(19) United States
(12) Patent Application Publication
(10) Pub. No.: US 2014/0239004 A1
(43) Pub. Date: Aug. 28, 2014

(54) Kitchen Counter Mountable Trash Bin

(71) Applicant: Timaree Anne Hagenburger, Lodi, CA (US)

(72) Inventor: Timaree Anne Hagenburger, Lodi, CA (US)

(21) Appl. No.: 13/775,883

(22) Filed: Feb. 25, 2013

(51) Int. Cl. B65F 1/14

(52) U.S. Cl. CPC B65F 1/141
USPC 220/751

(57) ABSTRACT

The present invention relates to a trash bin, which is suitable for hanging over a kitchen drawer or cabinet door under the kitchen counter. A particular feature of the trash bin of the present invention resides in the arrangement/relationship between the top rim of the trash bin and the mounting means. The mounting means include at least one over-the-door hook. Each hook includes a top member that mounts on the top frame of the drawer. The top member of the hook is positioned just beneath the top rim of the trash bin, thus, once the mounting means is hung over the top frame of the drawer, the top rim of the trash bin is almost leveled with the counter top, and thus, a user can simply wipe the trash off the counter top into the trash bin without missing any trash on the floor or on the cabinet.

### BACKGROUND OF THE INVENTION

1. Field of the Invention

The present invention relates to a trash bin with a mounting means, and more specifically to a kitchen counter mountable trash bin, which is suitable for hanging over a kitchen drawer or cabinet door under the kitchen counter.

2. Description of Related Art

It is common to place a kitchen trash bin (or garbage receptacle) on the ground (floor) in the kitchen. Normally, a person working in the kitchen uses one hand to wipe away the undesired materials (trash) from the counter top and uses another hand to receive and transfer the trash to the trash bin on the floor. If there is a lot of trash the person may repeat this action for several times. In order to minimize the number of repetition, the person may hold the trash bin with one hand and wipe the trash off the counter top with another hand. This action also decreases the efficiency. Moreover, the hand used to hold the trash bin needs to be thoroughly cleaned before touching clean food again. Cleaning hands also reduces the efficiency. Therefore there exists a need to have a kitchen trash bin that has a mounting means for easily hanging over a kitchen drawer so that a person working in the kitchen can hang the trash bin anywhere they are working in the kitchen.

Although there are commercially available garbage hanging kits in the marketplace, they are designed for a different purpose. The garbage hanging kits are designed for users who need their trash receptacles off the ground for space or safety reason. Therefore, the products do not meet the aforementioned need. The top rim of the garbage can is not leveled with the counter top even using the hanging kit. The trash may still fall on the floor when user wipes trash off the counter top.

Although a number of patents disclose trash bins that are conveniently secured to the inner face of an access door of a kitchen sink cabinet, for releasable engagement into the cabinet compartment under the sink including U.S. Pat. No. 4,991,913 to Van Wilder et al., U.S. Pat. No. 2,311,835 to Johnson, and U.S. Pat. No. 6,702,411 B2 to Helver, they do not meet the aforementioned need. The trash bins are still far away from the counter top, a person working in the kitchen cannot simply wipe the trash off the counter top and into the trash bin.

Thus, it is readily apparent that there exists an unmet need for a trash can having a mounting apparatus and method that allow easy access to the trash can and allow users to merely wipe the counter top off and into the trash bin without anything missing or getting onto the floor or on to the cabinet itself.

### SUMMARY OF THE INVENTION

One object of the present invention is to provide a trash bin that is within handy reach for filling so that a user can conveniently put trash away into trash bin.

Another object of the present invention is to provide a trash bin that is portable and easy to carry to and hang over kitchen furniture wherever a user is working.

Yet another object of the present invention is to provide a trash bin that may be mounted on the kitchen drawer or cabinet in a way that the top lip or rim of the trash bin is leveled with or closely beneath the counter top so that a user can simply wipe trash from the counter top and into the garbage bag of the trash bin.

In an exemplary embodiment of the present invention, there is disclosed a trash bin of the present invention, which is designed of the usual configuration, having a front wall, two side walls, which can be beveled or straight, a back wall, a bottom wall, and top lip or rim. The trash bin further includes a mounting means on the back of the trash bin for hanging over the top frame of a kitchen drawer or cabinet door under the counter top in the kitchen.

A particular feature of the invention resides in the arrangement/relationship between the top rim of the trash bin and the mounting means. The mounting means include at least one over-the-door hook. Each hook includes a top member that mounts on the top frame of the drawer. The top member of the hook is positioned just beneath the top rim of the trash bin, thus, once the mounting means is hung over the top frame of the drawer, the top rim of the trash bin is almost leveled with the counter top, and thus, a user can simply wipe the trash off the counter top without missing any trash on the floor.

The trash bin mentioned in the present invention may be with or without a bag or other liner therein.

In one embodiment, the mounting means of the present invention may be fabricated from slender metal rod stock. The mounting means may be attached to the trash bin by fastening means known in the art including but not limited to nuts and bolts.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a front and right side view of an embodiment of a trash bin according to the present invention.

FIG. 2 is a rear and left side view of an embodiment of a trash bin according to the present invention.

FIG. 3 is a right side view thereof, showing the particular relationship of the present invention with a kitchen counter.

### DESCRIPTION OF THE PREFERRED EMBODIMENT

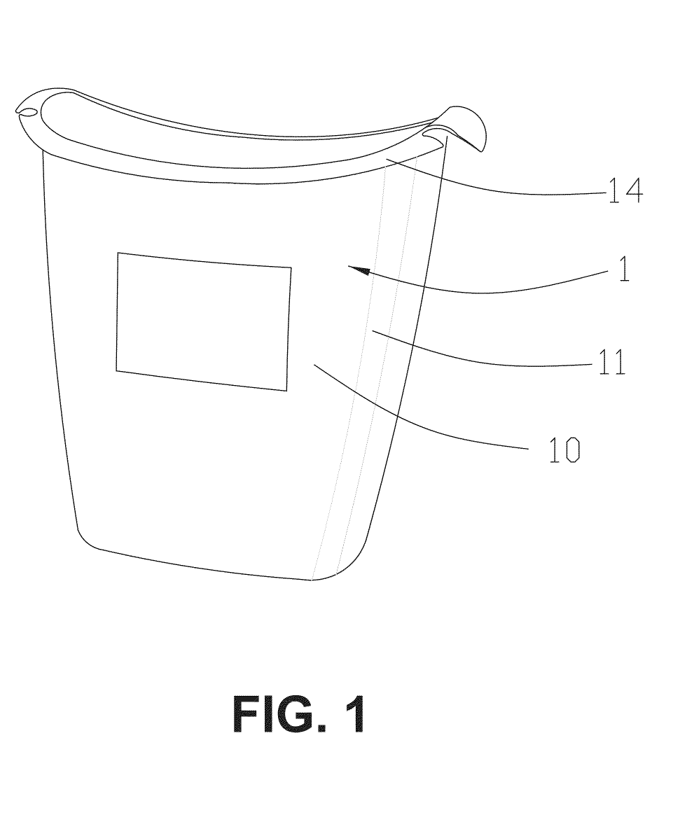

Referring to FIG. 1, there is disclosed a front and right side view of a trash bin 1 of this invention, which is designed of the usual configuration, having a front wall 10, two side walls 11, which can be beveled or straight, a back wall 12, a bottom wall 13 (not shown) and top lip or rim 14.

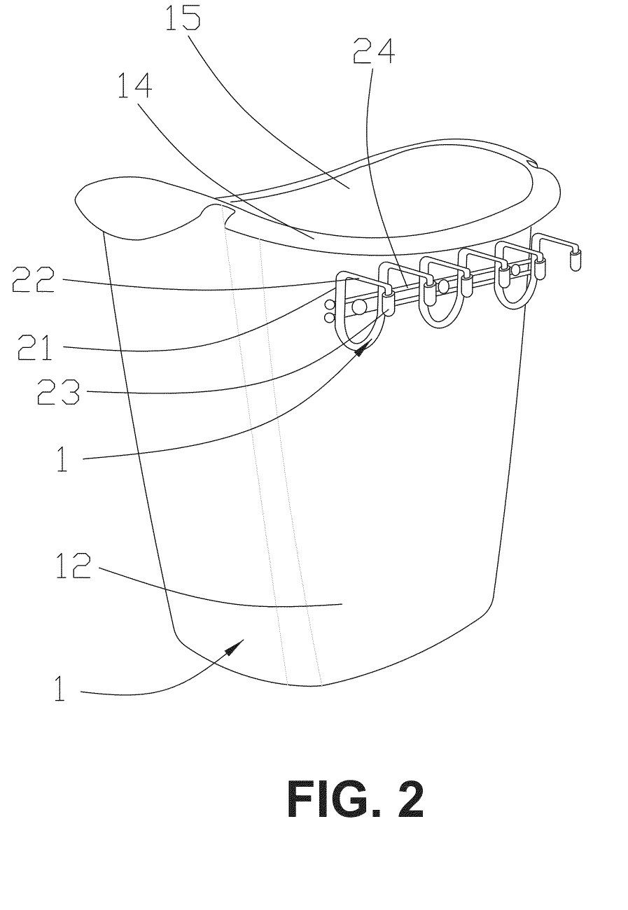

FIG. 2 discloses the rear and left side view of the trash bin 1 of the present invention, which has mounting means 2 on the back of the trash bin 1 for hanging over the top frame of a kitchen drawer 3 or cabinet door under the counter top 4 in the kitchen.

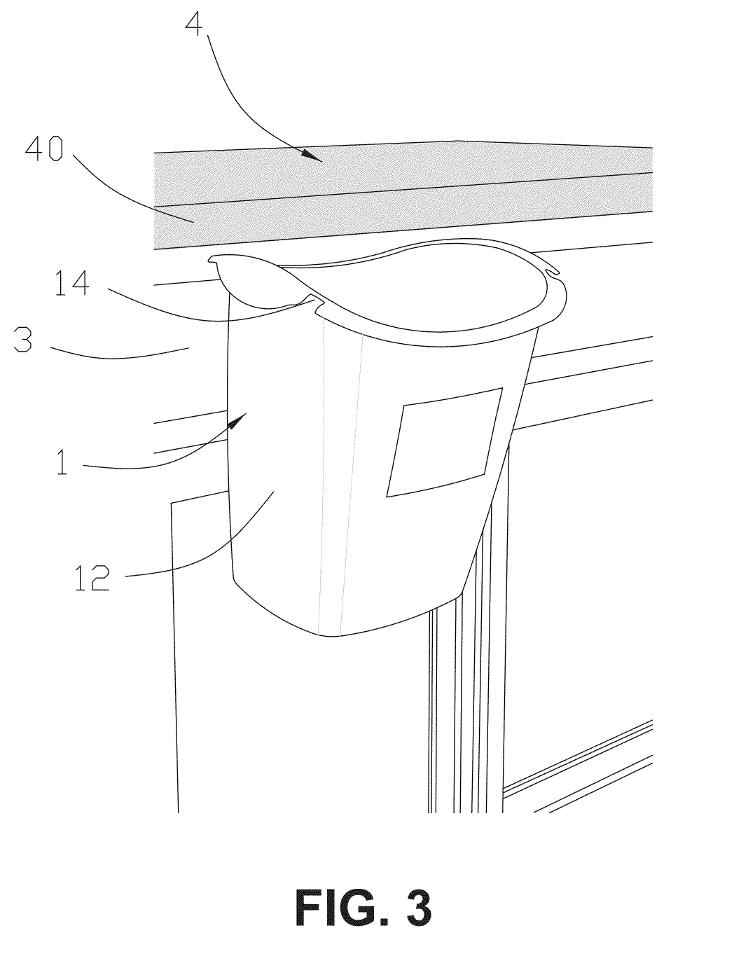

In referring to FIG. 3 the trash bin 1 of this invention is shown mounted in place, on the top frame of a kitchen drawer 3, through the usage of the mounting means 2 on the back of the trash bin 1.

A particular feature of the invention resides in the mounting means 2 which is installed on the back of the trash can 1 just beneath the top lip or rim 14. As disclosed in FIG. 2, the mounting means 2 may be fabricated from slender metal rod stock. The mounting means 2 has at least one hook 20, which is thin enough to fit between the top frame of the kitchen drawer 3 or cabinet door under the kitchen counter top and the frame of the kitchen counter and strong enough to hold significant weight.

In the embodiment disclosed in FIG. 2, the mounting means 2 include 3 pairs of over-the-door hooks 20 and two horizontal parallel metal bars 24 which have 3 evenly spaced nuts and bolts that penetrate the back wall 12 of the trash bin 1 to secure the mounting means 2 to the trash bin 1. The hook 20 hung over the top frame of the drawer 3 having a vertical front member 21, a horizontal top member 22 integrally connected to the upper edge of the vertical front member 21, and a vertical back member 23 integrally connected to the rear edge of the horizontal top member 22. The vertical front member 21 of the hook 20 being perpendicularly attached to the horizontal metal bars 24 continuously extends downwards and meets with the vertical front member 21 of another hook 20 to form a U shape.

The horizontal top member 22 of the hook 20 is designed to mount on the top frame of the drawer 3 and the vertical back member will be inside the drawer 3. The level of the horizontal top member 22 is designed to be lower than the level of the top rim 14 of the trash bin 1 so that when the trash bin 1 is mounted over the top frame of the drawer 3, the top rim 14 of the trash bin 1 is almost on the same level of or slightly lower than the counter top 40 as shown in FIG. 3.

Because the trash bin 1 is leveled with or closely beneath the counter top 40 so that a user can simply wipe trash from the counter top 40 into the trash bin 1.

The mounting means 2 further include at least one horizontally disposed metal bar 24 which is attached to the trash bin 1 via fastening means known in the art. The vertical front members 21 of over-the-door hooks 20 are connected to the horizontal disposed metal bar 24.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A kitchen counter mountable trash bin comprising:
a trash bin having a front wall, a back wall, two side walls, a bottom wall, and a top rim; and
means for mounting the trash bin on the top frame of a drawer under a kitchen counter so that the top rim of said trash bin is on the almost same level of the kitchen counter top.

2. The trash bin of claim 1, wherein the means for mounting including at least one over-the-door hook.

3. The trash bin of claim 2, wherein the over-the-door hook including a vertical front member, a horizontal top member integrally connected to the upper edge of the vertical front member, a vertical back member integrally connected to the rear edge of the horizontal top member; the horizontal top member is designed to be mounted on the top frame of the drawer, the vertical back member is inside the drawer, and the vertical front member is directly or indirectly attached to the back wall of the trash bin; the level of the horizontal top member is designed to be lower than the level of the top rim of the trash bin so that when the trash bin is mounted over the top frame of the drawer, the top rim of the trash bin is almost on the same level of the kitchen counter top or slightly below the counter top.

4. The trash bin of claim 1, wherein the means for mounting may be fabricated from slender metal rod stock.

5. The trash bin of claim 1, wherein the means for mounting further including horizontally disposed metal bar which is attached to the trash bin via fastening means known in the art, the vertical front members of over-the-door hooks are connected to the horizontally disposed metal bar.

6. A kitchen counter mountable trash bin comprising:
a trash bin having a front wall, a back wall, two side walls, a bottom wall, and a top rim; and
means for mounting including at least one over-the-door hook which including a vertical front member, a horizontal top member integrally connected to the upper edge of the vertical front member, a vertical back member integrally connected to the rear edge of the horizontal top member; the horizontal top member is designed to be mounted on the top frame of the drawer, the vertical back member is inside the drawer, and the vertical front member is directly or indirectly attached to the back wall of the trash bin; the level of the horizontal top member is designed to be lower than the level of the top rim of the trash bin so that when the trash bin is mounted over the top frame of the drawer, the top rim of the trash bin is almost on the same level of the kitchen counter top or slightly below the counter top.

7. The trash bin of claim 6, wherein the means for mounting may be fabricated from slender metal rod stock.

8. The trash bin of claim 6, wherein the means for mounting further including horizontally disposed metal bar which is attached to the trash bin via fastening means known in the art, the vertical front members of over-the-door hooks are connected to the horizontally disposed metal bar.

9. A kitchen counter mountable trash bin comprising:
a trash bin having a front wall, a back wall, two side walls, a bottom wall, and a top rim; and
means for mounting include 3 pairs of over-the-door hooks and two horizontal metal bars which have 3 evenly spaced nuts and bolts that penetrate the back wall of the trash bin to secure the mounting means to the trash bin; the hook hung over the top frame of the drawer having a vertical front member, a horizontal top member integrally connected to the upper edge of the vertical front member, and a vertical back member integrally connected to the rear edge of the horizontal top member; the vertical front member of the hook being perpendicularly attached to the horizontal metal bars continuously extends downwards and meets with the vertical front member of another hook to form a U shape; the horizontal top member of the hook is designed to mount on the top frame of the drawer and the vertical back member will be inside the drawer. The level of the horizontal top member is designed to be lower than the level of the top rim of the trash bin so that when the trash bin is mounted over the top frame of the drawer, the top rim of the trash bin is almost on the same level of or slightly lower than the counter top.

10. The trash bin of claim 9, wherein the means for mounting may be fabricated from slender metal rod stock.
